(19) United States
(12) Patent Application Publication
(10) Pub. No.: US 2002/0074182 A1
(43) Pub. Date: Jun. 20, 2002

(54) Differential steering actuator

(76) Inventor: Michael James Cole, Saginaw, MI (US)

Correspondence Address: EDMUND P. ANDERSON DELPHI TECHNOLOGIES, INC., Legal Staff, Mail Code: 480-414-420, P.O. Box 5052, Troy, MI, 48007-5052, US

(21) Appl. No.: 09/742,476

(22) Filed: Dec. 20, 2000

(51) Int. Cl. B62D 5/06; B62D 5/04

(52) U.S. Cl. 180/417; 180/444

(57) ABSTRACT

A differential steering actuator having a driver input shaft mechanically communicable with a steering shaft, a sun gear in direct mechanical communication with the driver input shaft, an output gear, an idler gear/ring gear system in mechanical communication with the sun gear and the output gear, and an output shaft fixedly connected to the output gear and ultimately being cooperably connectable to the steerable wheels of a motor vehicle. The idler gear/ring gear system includes a ring gear, at least one idler gear rotatably mounted to the ring gear, and a differential motor configured to drive the ring gear. The sun gear and the output gear are both beveled and are positioned such that the faces thereof are in a parallel planar relationship. The idler gears are mounted to the inner surface of the ring gear, which is driven by the differential motor, and are positioned to engage both the sun gear and the output gear.

### TECHNICAL FIELD

This invention relates to a steering actuator for a motor vehicle having a variable steering ratio between the driver input and the steering actuator output.

### BACKGROUND

Various types of steering equipment for assisting a driver in the steering of a motor vehicle exist. To aid the driver, many steering systems utilize an auxiliary system to generate a force that is transmitted to a steering gear assembly. This additional force reduces the effort required by the driver in changing the direction of the vehicle. Typically, this auxiliary force is generated by either a hydraulic drive or an electric motor.

In conventional steering assemblies, the driver controls the direction of the vehicle with the aid of a hand steering wheel, which communicates through the steering gear assembly with the steerable wheels of the vehicle. Rotation of the hand steering wheel is converted into the lateral motion of a steering rod via a steering gear, which is typically a rack and pinion mechanism. The steerable wheels are rotatably mounted to the ends of tie rods, which are then laterally moved in response to the lateral motion of the steering rod.

In conventional steering systems, the overall steering ratio is the fixed kinematic relationship between the hand steering wheel angle and the position of the steerable wheels. In other words, the hand steering wheel angle, which is a function of the driver input, is in a one-to-one ratio with the angle of the steerable wheels, which is a function of the steering actuator output.

### SUMMARY

A differential steering actuator is capable of adjusting the steering ratio by creating an active differential effect between the driver input and the steering actuator output. A differential gear arrangement has a rotating idler gear/ring gear assembly to allow a controlled change to be made to the steering angle of the steerable wheels input by the driver through the hand steering wheel. The amount of variation between the driver input and the steering actuator output is virtually infinite and will default to a one-to-one ratio in the event that the driver elects not to utilize the differential steering or when the differential steering becomes non-functional. A non-backdrivable gear interface situated between the drive element and the rotating idler gear/ring gear assembly prevents the backdriving of the differential steering actuator due to road forces encountered.

In the differential steering actuator, a steering shaft is mechanically communicable with a differential steering actuator. The differential steering actuator includes a driver input shaft, a sun gear in direct mechanical communication with the driver input shaft, an output gear, an idler gear/ring gear assembly in mechanical communication with the sun gear and the output gear, and an output shaft fixedly connected to the output gear and ultimately being cooperably connectable to the steerable wheels of a motor vehicle. The idler gear/ring gear assembly includes a ring gear, at least one idler gear rotatably mounted to the ring gear, and a differential motor configured to drive the ring gear. The sun gear and the output gear are both beveled and are positioned such that the faces thereof are in a parallel planar relationship with each other. The idler gears are mounted to the inner surface of the ring gear, and are positioned to engage both the sun gear and the output gear. Rotation of the idler gears to create the differential effect is effected by the driving of the ring gear.

The differential motor, which is generally actuatable by a controller within the motor vehicle and is variably responsive to parameters such as vehicle speed, wheel angle, vehicle yaw rate, and other factors, drives a worm gear that drives the ring gear. The differential motor may be configured to be non-backdrivable and is generally operated under electromechanical or hydro-mechanical power.

### DESCRIPTION OF THE DRAWINGS

FIG. 1 is a perspective view of a steering system embodying a differential steering actuator as it would be positioned within a motor vehicle.

FIG. 2 is an elevation view of the differential steering actuator.

FIG. 3 is a perspective view of the differential steering actuator.

FIG. 4 is a perspective view of an idler gear engaged with an output gear.

FIG. 5 is a perspective view of an idler gear/ring gear assembly engaged with an output gear.

FIG. 6 is an elevation view of an alternate embodiment of the differential steering actuator.

FIG. 7 is a perspective view of an alternate embodiment of the differential steering actuator.

### DETAILED DESCRIPTION

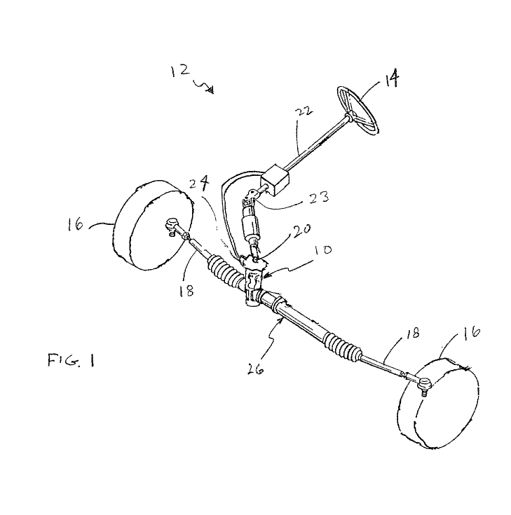

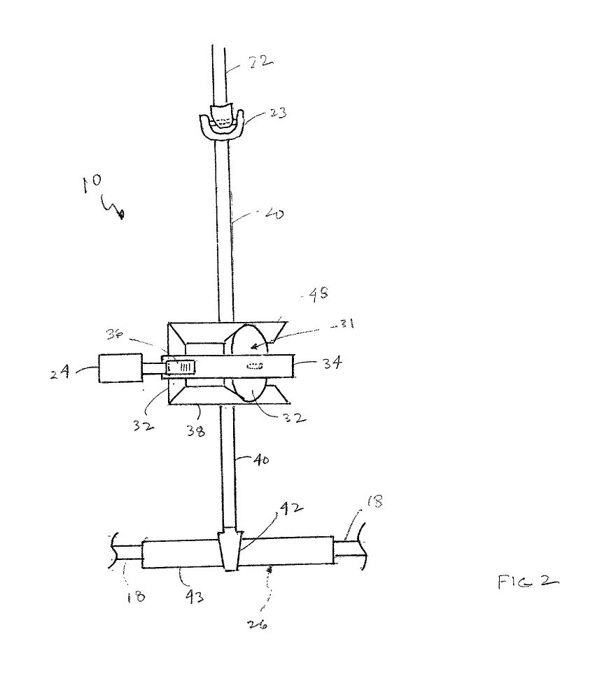

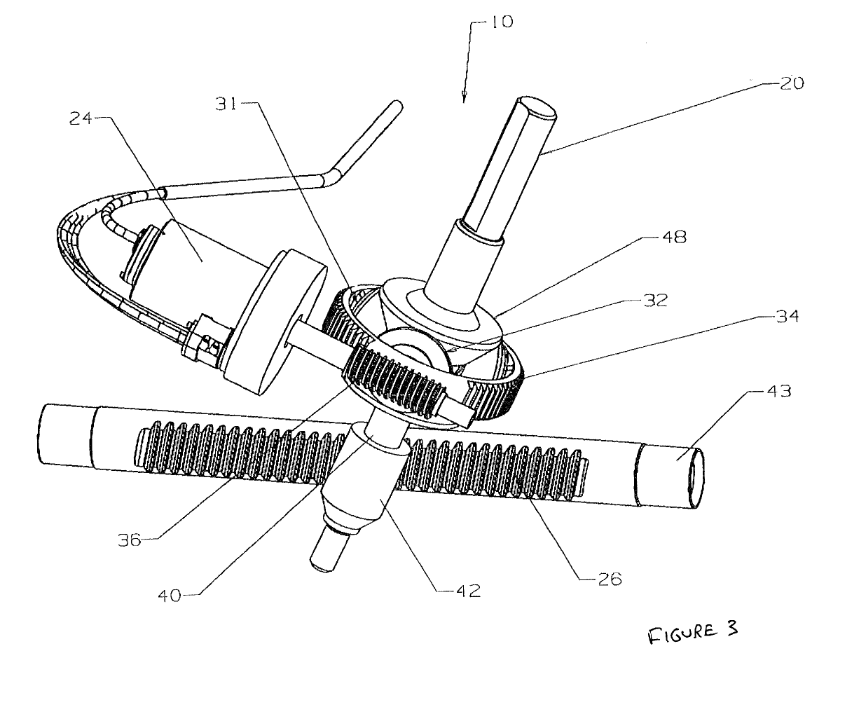

Referring to FIG. 1, a differential steering actuator is shown generally at 10, as it would be positioned within a steering system, shown generally at 12, of a motor vehicle (not shown). Steering system 12 includes a hand steering wheel 14 operatively connected to a pair of steerable wheels 16 of the vehicle via differential steering actuator 10, tie rods 18, and other linkages. A hand steering wheel 14 receives input from a driver (not shown). Hand steering wheel 14 is connected to a steering shaft 22, which is connected to a joint 23, which is in turn pivotally connected to differential steering actuator 10 at an upper end of driver input shaft 20. A lower end of driver input shaft 20 is in mechanical communication with a gear system (shown below with reference to FIGS. 2 and 3), which is assisted by a differential motor 24. A steering rod, shown generally at 26, is operatively connected to the gear system and laterally movable to change the position of steerable wheels 16 relative to the motor vehicle, thereby altering the directional movement of the motor vehicle.

Referring now to FIGS. 2 and 3, differential steering actuator 10 is shown positioned intermediate steering shaft 22 and tie rods 18. Differential steering actuator 10 comprises driver input shaft 20, a beveled sun gear 48, an idler gear/ring gear system shown generally at 31, a beveled output gear 38, and an output shaft 40 having a pinion 42 thereon that translates the rotational input of the driver input shaft 20 into the lateral motion of steering rod 26. Driver input shaft 20 is drivingly connected at one end thereof to steering shaft 22 through joint 23, which can be a universal joint (shown above with reference to FIG. 1), thereby enabling driver input shaft 20 to be controlled by the axial rotation of steering shaft 22 while driver input shaft 20 and steering shaft 22 are not in a coaxial relationship.

Driver input shaft 20 drives sun gear 48. The fixed connection of driver input shaft 20 with sun gear 48 allows sun gear 48 to be driven in a one-to-one ratio with the rotation of hand steering wheel 14. Sun gear 48, which is configured to be in a reverted gear set arrangement with output gear 38, is fixedly connected at the hub thereof to driver input shaft 20 and is configured to be in rotatable communication with output gear 38 through idler gear/ring gear assembly 31. Output gear 38 is fixedly connected to output shaft 40, which depends axially from the hub of output gear 38.

In a typical gear assembly, an idler gear having a conventional external configuration, when in communication with another gear having the same conventional external configuration, necessarily rotates in the opposite direction as the other gear. An idler gear positioned intermediate two conventional hub-type gears having external configurations enables the two hub-type gears to rotate in the same direction while maintaining the same rotational speed. In the present invention, idler gears 32 in the gear configuration illustrated engage the beveled edges of both sun gear 48 and output gear 38 and allow for the rotation of output shaft 40 in the same direction as driver input shaft 20, which is in direct communication with hand steering wheel 14.

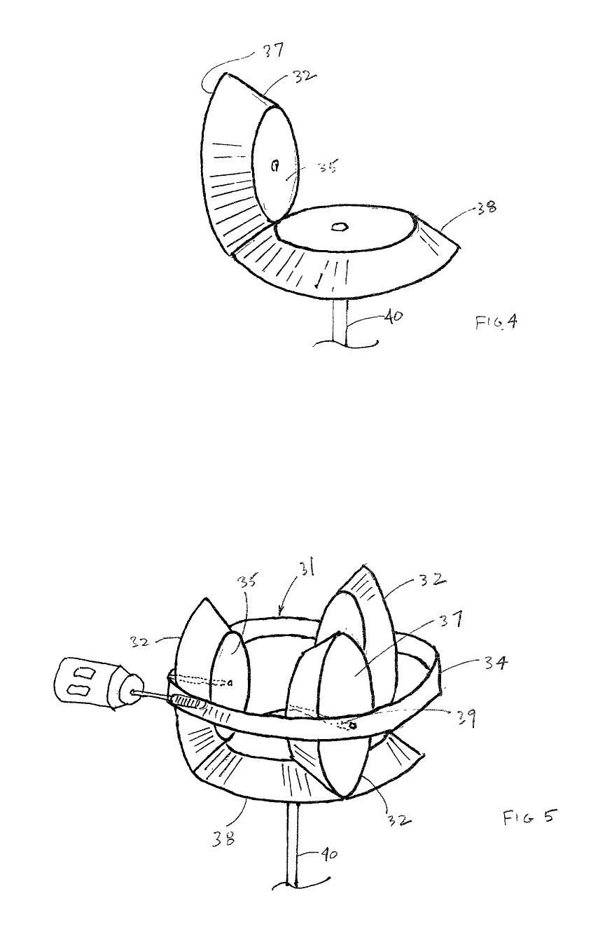

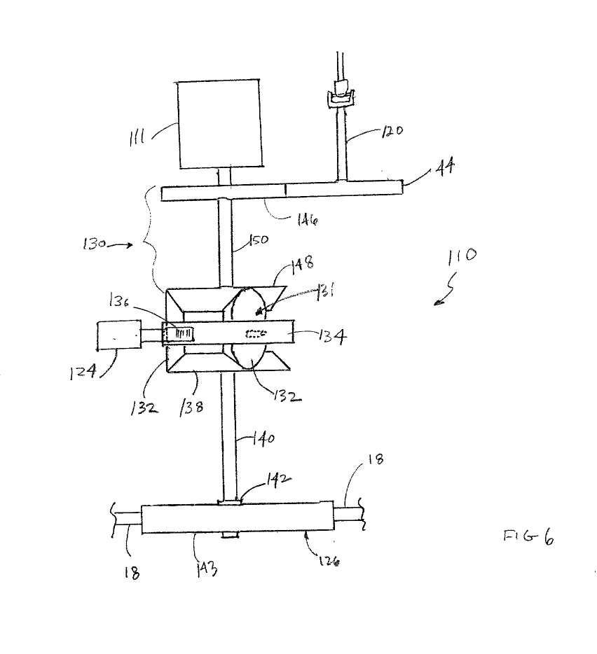

Referring now to FIGS. 4 and 5, idler gear/ring gear assembly 31 comprises a ring gear 34, idler gears 32 rotatably mounted to ring gear 34, and a differential motor 24 configured to drive ring gear 34. Idler gears 32 each have a face 35 and an opposing face 37. The rotation of idler gears 32 about the perimeter of the beveled portion of output gear 38, assisted by the driving of ring gear 34, drives output gear 38 and thereby provides a differential effect to the output. Idler gears 32, which are frustoconically shaped gears rotatably positioned equiangularly intermediate sun gear 48 (shown in FIGS. 2 and 3) and output gear 38, transfer rotational motion between sun gear 48 and output gear 38 to drive output shaft 40.

In FIG. 5, idler gears 32 are shown as being mounted on the inside surface of ring gear 34. Ring gear 34 is a hoop-like structure having a toothed outer surface. Idler gears 32 are spaced at equidistant points around the inside surface of ring gear 34, and each is rotatably supported on ring gear 34 by a pin 39 protruding from the inside surface of ring gear 34 and extending into opposing face 37 of idler gear 32. Ring gear 34 and idler gears 32 are dimensioned to allow sun gear 48 (shown in FIGS. 2 and 3) and output gear 38 to remain in mechanical communication through the idler gear/ring gear assembly 31.

Referring back to FIGS. 2 and 3, differential motor 24 is shown being in mechanical communication with ring gear 34 via worm gear 36. Worm gear 36, through differential motor 24, allows for a controlled change to be made to the driver input as a result of the movement of hand steering wheel 14 to give a variable output to steering rod 26. Differential motor 24 is controlled by a control circuit (not shown) that is responsive to the output of sensors (not shown) in such a manner that the operation and speed of differential motor 24 can be varied in response to parameters such as the vehicle speed, the angle of steerable wheels 16 relative to the vehicle, the speed at which hand steering wheel 14 is rotated, vehicle yaw rate, and other factors.

The operation of differential steering actuator 10 is a result of worm gear 36 driving ring gear 34. When ring gear 34 is not driven, idler gears 32 rotate in place between sun gear 48 and output gear 38. In such a case, output shaft 40 rotates in a one-to-one ratio with driver input shaft 20. Once worm gear 36 drives ring gear 34, idler gears 32 are forced to rotate about the beveled surfaces of sun gear 48 and output gear 38. This rotation results in the increased rotational speed of output shaft 40, which ultimately causes the increased speed of the lateral movement of steering rod 26 and steerable wheels 16. The amount of variation between the driver input and the actuator output is infinite and is configured to default to a one-to-one ratio in the event that differential steering actuator 10 becomes non-functional either at the election of the driver or by malfunction of the system.

Still referring to FIGS. 2 and 3, steering rod 26 comprises a pinion 42 and a rack 43. Pinion 42 is fixedly attached to an end of output shaft 40 opposite output gear 38 and is configured to engage rack 43 in a manner that is well known in the art. Since the ends of rack 43 are connected to tie rods 18, which are ultimately connectable to steerable wheels 16 via structures also well known in the art, any movement of rack 43 necessitates movement of steerable wheels 16 to alter the directional movement of the motor vehicle. Rack 43 is positioned to engage pinion 42 such that when output shaft 40 axially rotates, rack 43 moves in the proper lateral direction to properly position steerable wheels 16.

The interface between worm gear 36 and ring gear 34 can be configured to be non-backdrivable, thereby preventing differential steering actuator 10 from absorbing forces encountered due to variations in road surfaces that are ultimately transferred back to the driver through hand steering wheel 14. Differential motor 24 may operate under either electric or hydraulic power. If differential motor 24 is hydraulically operated, the internal components thereof should be configured in such a manner so as to prevent backdrivability.

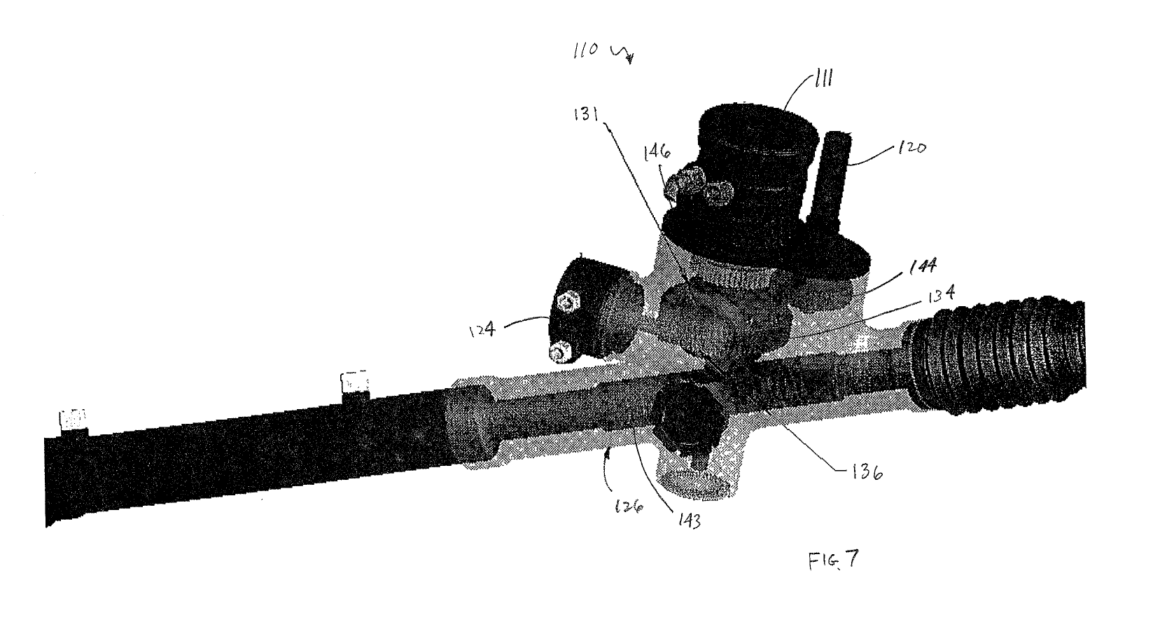

Referring to FIGS. 6 and 7, an alternate embodiment of the inventive differential steering actuator 10 is illustrated in which all components are numbered in multiples of one hundred. A non-backdrivable differential steering actuator is shown generally at 110. Non-backdrivable differential steering actuator 110 can be substituted in place of differential steering actuator 10 in steering system 12 of FIG. 1. However, non-backdrivable differential steering actuator 110 includes a valve 111, which may be either hydraulically- or electrically operated, positioned proximate and in direct communication with the gear arrangement thereof.

Non-backdrivable differential steering actuator 110 comprises a driver input shaft 120, a driver input gear 144, a drive reversing/sun gear system shown generally at 130, an idler gear/ring gear system shown generally at 131, a beveled output gear 138, and an output shaft 140 having a pinion 142 thereon that translates driver input into the lateral motion of a steering rod 126.

In particular, driver input gear 144 is rotated in a one-to one ratio with driver input shaft 120 via driver input. Driver input gear 144 drivingly engages drive reversing/sun gear system 130, which comprises a reversing gear 146 and a beveled sun gear 148 fixedly connected at the hubs thereof by a reversing gear shaft 150. The rotational motion of reversing gear 146 is in the opposite direction as the rotational motion of driver input gear 144. The rotational motion of drive reversing gear 146 is transferred to sun gear 148 through reversing gear shaft 150. Idler gear/ring gear assembly 131 comprises idler gears 132 rotatably supported within a ring gear 134, and is driven by a worm gear 136 and a motor 124 to engage output gear 138 the same way as in the preferred embodiment.

Output gear 138 is fixedly connected to output shaft 140, which depends axially from output gear 138, as in the preferred embodiment. However, because reversing gear 146 reverses the direction of rotation of driver input shaft 120, the direction of rotation of output shaft 138 is reversed. A rack 143 driven by pinion 142 is therefore driven in such a manner so as to laterally move tie rods 118 to steer the steerable wheels (not shown) in the opposite direction that a hand steering wheel (not shown) is rotated. In order to compensate for this reversal, rack 143 is positioned “backwards” within the motor vehicle such that pinion 142 engages rack 143 from the side that is opposite the side that pinion 42 would engage rack 43 in steering system 12.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. A differential steering actuator comprising:
a driver input shaft mechanically communicable with a steering shaft;
a sun gear in direct mechanical communication with said driver input shaft;
an output gear;
an idler gear/ring gear system in mechanical communication with said sun gear and said output gear;
an output shaft fixedly connected to said output gear and ultimately being mechanically communicable with steerable wheels of a motor vehicle.

2. The differential steering actuator of claim 1 wherein said sun gear is beveled toward a face thereof.

3. The differential steering actuator of claim 2 wherein said output gear is beveled toward a face thereof.

4. The differential steering actuator of claim 3 wherein said idler gear/ring gear system comprises,
a ring gear,
at least one idler gear rotatably mounted to said ring gear, and
a differential motor configured to drive said ring gear.

5. The differential steering actuator of claim 4 wherein a face of said at least one idler gear is perpendicularly situated to a face of said sun gear and perpendicularly situated to a face of said output gear.

6. The differential steering actuator of claim 4 wherein said at least one idler gear is frustoconically-shaped and dimensioned to communicably engage said sun gear and said output gear.

7. The differential steering actuator of claim 6 wherein said at least one idler gear is rotatably supported by a pin extending from an inside surface of said ring gear to an opposing face of said at least one idler gear.

8. The differential steering actuator of claim 4 wherein said differential motor drives a worm gear, which in turn drives said ring gear.

9. The differential steering actuator of claim 8 wherein said differential motor is actuatable by a controller, said controller being variably responsive to parameters of said motor vehicle.

10. The differential steering actuator of claim 8 wherein said differential steering actuator is geared so as to be non-backdrivable.

11. The differential steering actuator of claim 10 wherein a reversing gear is positioned intermediate said driver input shaft and said sun gear.

12. The differential steering actuator of claim 10 wherein said differential motor is operated under electromechanical power.

13. The differential steering actuator of claim 10 wherein said differential motor is operated under hydro-mechanical power.
